(19) United States
(12) Patent Application Publication
(10) Pub. No.: US 2008/0101062 A1
(43) Pub. Date: May 1, 2008

(54) Lighting device for projecting a beam of light

(75) Inventors: Jian Feng, Hong Kong (CN); Shengmei Zheng, Hong Kong (CN); Yong Cai, Jiangsu Province (CN); Hung-Shen Chu, Hsinchu (TW)

Correspondence Address: WELLS ST. JOHN P.S., 601 W. FIRST AVENUE, SUITE 1300, SPOKANE, WA, 99201, US

(73) Assignee: Hong Kong Applied Science and Technology Research Institute Company Limited

(21) Appl. No.: 11/881,039

(22) Filed: Jul. 24, 2007

Related U.S. Application Data
(63) Continuation of application No. 11/588,719, filed on Oct. 27, 2006.

(51) Int. Cl. F21V 7/00; F21V 9/00

(52) U.S. Cl. 362/231; 362/297

(57) ABSTRACT

A light source for a lighting device has a reflector for receiving one or more light emitting diode devices. The reflector has reflective sides and a light exit. There is a side emitting LED device located in the reflector such that its primary light emitting direction towards the reflective sides such that light emitted from the LED device are reflected towards the light exit.

This application claims priority from U.S. patent application Ser. No. 11/588,719 filed 27 Oct. 2006, the contents of which are incorporated herein by reference.

### BACKGROUND OF THE INVENTION

1. Field of the Invention

The present invention relates to lighting devices and more particularly to lighting devices used to project a beam of light in such things as a flashlights, vehicle headlights and projection devices. The invention also relates to light emitting diodes (LEDs) for use in lighting devices.

2. Background Information

Light emitting diode (LED) lighting devices are well known in the art. LEDs are an excellent light source for indirect and ambient lighting. However, the use of LEDs lighting devices that project a beam of light is not widespread because they have lower light output compared with than other more suitable light sources and poor topography for use with beam reflectors. High power LEDs are available which can be used in smaller projecting devices such as LED clocks that project the time and date information onto the wall or ceiling of a room. However, these devices are not yet suitable for application in light projecting devices that require higher beam intensities such as motor vehicle headlights or image display projectors.

Accordingly, it is an object of the present invention to provide an LED lighting device for projecting a beam of light which has a higher light output intensity than known LED lighting devices, or which at least provide the public with a useful internative.

### SUMMARY OF THE INVENTION

In view of the foregoing, there is disclosed herein a light source for a lighting device comprising a reflector for receiving one or more light emitting diode devices, said reflector having reflective sides and a light exit, and a side emitting LED device located in the reflector and having its primary light emitting directions towards the reflective sides such that light emitted from the LED device are reflected towards the light exit.

Preferably, the reflector is selected from a group consisting of a cup, dish, cone, or channel.

Preferably, the reflector is a reflective channel for receiving an array of the side emitting LED devices.

Preferably, the array of the side emitting LED devices comprises successive red, green and blue side emitting LED devices.

Preferably, the light source further comprises a plurality of adjacent reflective channels, each channel receiving only a plurality of red or green or blue side emitting LED devices, wherein adjacent reflective channels have successive pluralities of red, green and blue side emitting LED devices.

Preferably, the cup, dish, cone, or channel has a parabolic shaped inner surface having a reflective finish.

Preferably, the reflector has a focal point and the side emitting LED device is mounted on a mounting device such that the light emitting region center is located adjacent the focal point.

There is also disclosed herein a lighting device for projecting a bean of light, comprising a light reflector having a mounting surface surrounded by parabolic shaped reflective sides and a light exit, and a light emitting diode devices fabricated for mounting to the mounting surface with a plane occupied by light emitting regions of the devices substantially perpendicular to a plane occupied by the mounting surface such that light emissions of the light emitting regions are projected towards the parabolic sides of the reflector are reflected towards the light exit.

Preferably, the light reflector has a focal point and the light emitting diode is located adjacent the focal point so that light projected towards the parabolic sides of the reflector is reflected towards the light exit in a highly collimated light beam.

There is yet further disclosed herein a light source for a lighting device, comprising a light reflector having a mounting surface surrounded by reflective sides and a light exit, for receiving one or more light emitting diode device, and light emitting diode devices fabricated for mounting to the mounting surface with the plane occupied by light emitting regions of the devices substantially perpendicular to the plane occupied by the mounting surface such that light emissions of the light emitting regions are projected towards the reflective sides of the reflector are reflected towards the light exit.

Further aspects and disclosure of the invention are provided in and will become apparent from the following description.

### BRIEF DESCRIPTION OF THE DRAWINGS

An exemplary form of the present invention will now be described by way of example only and with reference to the accompanying drawings, in which:

FIG. 1 is a schematic perspective illustration of a side edge bonded light emitting diode (LED) device,

FIG. 2 is a schematic side elevation illustration of the LED device of FIG. 1,

FIG. 3 illustrates the light emission pattern of the LED device of FIGS. 1 and 2,

FIG. 4 is a schematic illustration is the LED in a reflector according to the invention,

FIG. 5 is a second schematic illustrations is the LED in a reflector,

FIG. 6 is a schematic illustration of a first embodiment of a LED array for a display projector according the invention,

FIG. 7 is a schematic illustration of a second embodiment of a LED array for a display projector according the invention, and

FIG. 8 is a graph of test data comparing intensity output of a lighting device employing top emitting (TE) and side edge bonded (EBo) LEDs in a reflector.

### DESCRIPTION OF THE EXEMPLARY EMBODIMENTS

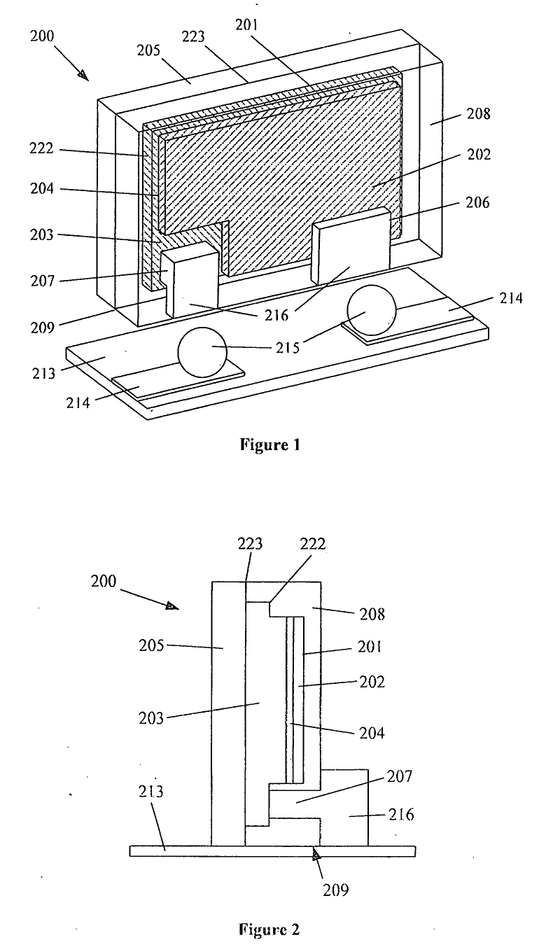

Three of the inventors, Feng, Zheng and Chu, have proposed in an earlier U.S. patent application Ser. No. 11/588,719 filed 27 Oct. 2006 a side edge bonded LED device. The entire contents of Ser. No. 11/588,719 are incorporated herein by reference. An exemplary embodiment of this light emitting diode (LED) device is schematically illustrated in FIGS. 1 and 2. The device 200 comprises a multi-layer semiconductor substrate 201 having a first layer 202 of a p-doped or p-type semiconductor material and a second layer 203 of a n-doped or n-type semiconductor material. The two semiconductor layers 202, 203 are located together to form a p-n semiconductor junction. As is known in the art, a depletion layer is formed at the p-n junction that forms a light emitting region 204 of the LED device 200. When a voltage is applied across the p-n junction electrons and holes flow into the junction and when an electron meets a hole it falls into a low energy level which releases a photon. These light photons are emitted in all directions from the junction but the primary direction of emitted light is perpendicular to a plane occupied by the p-n junction between the p-type and n-type semiconductor layers 202, 203.

A p-terminal 206 and a n-terminal 207 are provided connected to the p-type and n-type semiconductor layers 202, 203 respectively for conducting power to the layers. The p- and n-terminals 206, 207 have contact pads 216 that overlap the perimeter 222 of the semiconductor substrate 201 to a position substantially in line with a mounting edge 209 of the LED device 200.

The semiconductor substrate 201 is formed on a light transmissive substrate 205. The light transmissive substrate 205 is preferably Sapphire and is larger than the semiconductor substrate 201 so that its perimeter 223 is greater than a perimeter 222 of the semiconductor substrate 201 and the semiconductor substrate 201 is entirely located within the perimeter 223 of the light transmissive substrate 205. A layer 208 of light transmissive material is provided on an opposite side of the semiconductor substrate 201 sandwiching the semiconductor substrate 201 between the light transmissive layer 208 and the light transmissive substrate 205. The light transmissive layer 208 is in contact with the light transmissive substrate 205 at its perimeter to totally passivate both the p-type and n-type layers 202, 203 of the semiconductor substrate 201. Contact surfaces of the n- and p- terminals 206, 207 are left exploded at the outer surface of the light transmissive layer 208 along the mounting edge 209 of the LED device 200.

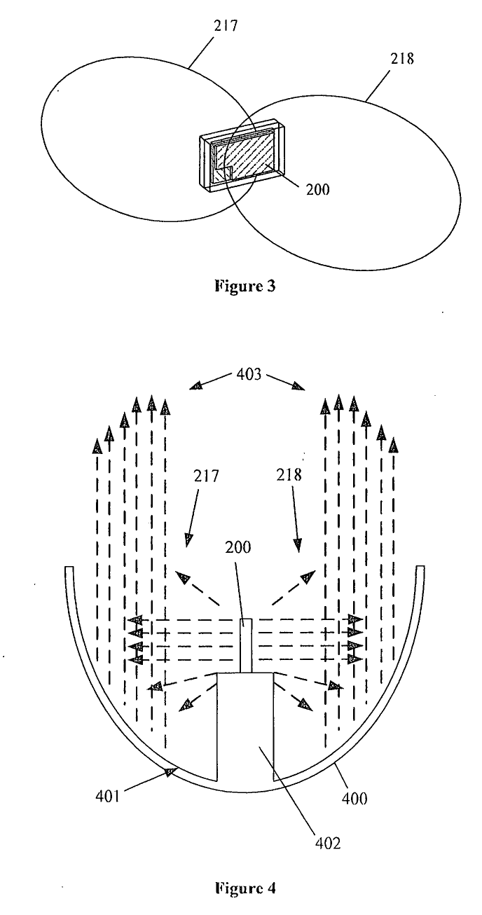

The LED device 200 is fabricated to have a passive mounting edge 209 with adjacent p- and n-terminals 206, 207 so that the device 200 can be edge mounted on to a mounting surface 213 with the plane occupied by the light emitting region 204 perpendicular to a plane occupied by the mounting surface 213. The LED device 200 is secured to the mounting surface 213 as with a surface mount device by the exposed contact pads 216 of the p- and n-terminals 206, 207 bonded with solder balls 215 of an electrical circuit 214 on the mounting surface 213. The mounting surface 213 can be a printed circuit board (PCB) or other mounting substrate known in the art. The edge mounted LED device 200 has primary light emission directions that are parallel to the plane occupied by the mounting surface 213. If the light transmissive layer 208 and light transmissive substrate 205 have substantially similar refractive indexes then the light emission patterns 217, 218 of the LED device in the primary directions will be a substantially uniform ovoid shapes as illustrated in FIG. 3.

The LED device 200 is used in a new and improved lighting device for projecting a beam of light by mounting the LED within a reflector having parabolic shape reflective sides such that light emissions from the LED are emitted in a sideways direction towards to the parabolic sides of the reflector and are reflected outwards from the reflector in a collimated beam. Such a lighting device is illustrated in FIG. 4.

Referring to FIG. 4, a reflector 400, which can be a cup, dish, cone or cannel, has a parabolic shaped inner surface 401 that is finished or coated to be highly reflective. A mounting device 402 is provided in the reflector for supporting the side emitting LED 200 at or near the focal point of the reflector. The sideways light emissions 217, 218 from the LED 200 are reflected from the inner surface 401 of the reflector 400 and projected in a collimated beam away from the reflector 400.

FIG. 5 shows an alternative embodiment of the lighting device where the reflector comprises the mounting surface 213 of the LED device 200 with upwardly extending walls 406 and 407 which are angled to reflect light emitted from the LED 200 in an outwardly projecting beam 408.

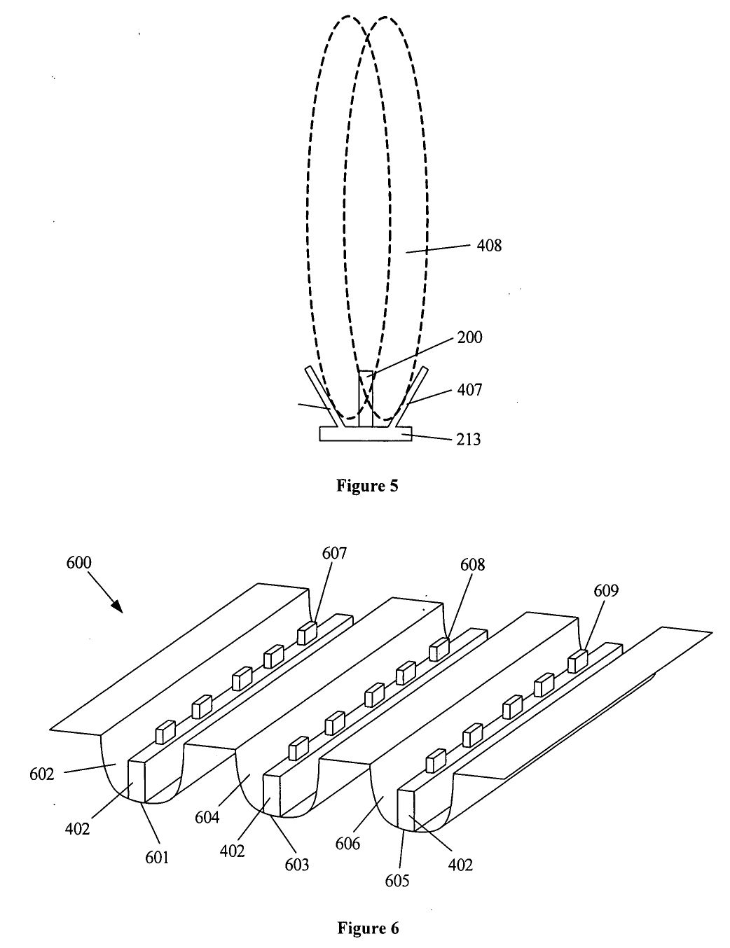

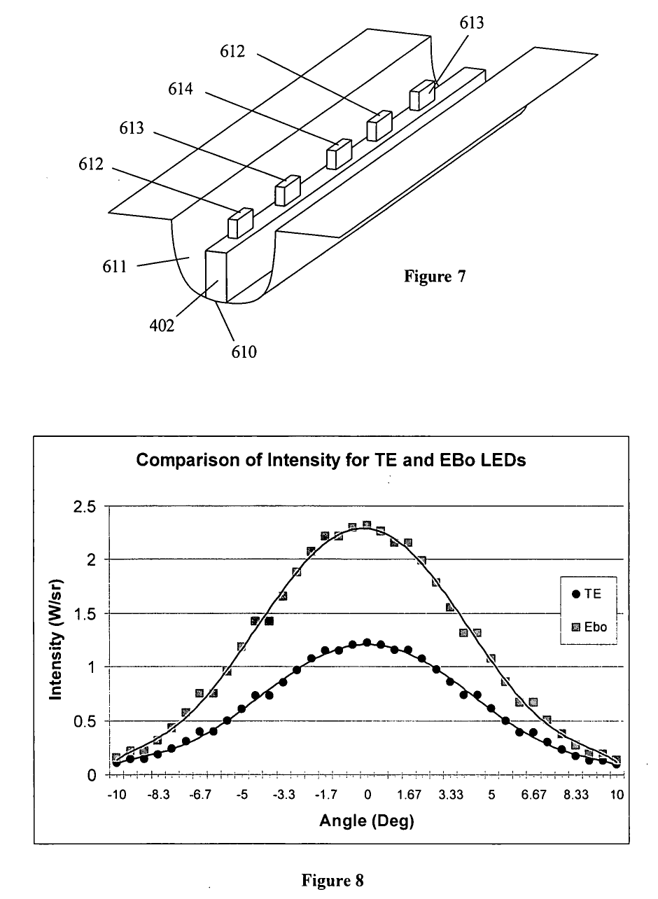

FIGS. 6 and 7 illustrate first and second embodiments of a lighting device according to the invention which can be used in a display projector. In the first embodiment illustrated in FIG. 6 a lighting device for a projector 600 comprises a plurality of parallel channels 601, 603 and 605. Each channel has parabolic shaped reflective sides 602, 604 and 606 respectively. Each channel receives a row 607, 608 and 609 of LED devices, as described above with referenced to device 200, that have sideways light emission patterns that emit light towards the reflective sides 602, 604 and 606 of the respective channels 601, 603 and 605. The sideways emitted light is reflected upwards and outward from the channels as illustrated in FIGS. 4 and 5. In the device 600, successive channels have different ones of red 607, green 608 and blue 609 LEDs. That is to say, channel 601 has a row of red LEDs 607, channel 603 has a row of green LEDs 608 and the next channel 605 has a row of blue LEDs 609. The successive channels have an alternate row of red, green and blue LEDs in sequence the pattern continues through all chancels of the device 600. Thus, the lighting device 600 for a projector can output a light beam of different colours by controlling the light intensity of the different coloured LEDs chancels. For a white light output all LEDs are illuminated with the same intensity. As is well known in the art equal intensities of red, green and blue light produces white light. Varying the intensities of different ones of the three colours red, green and blue produces different coloured light.

A second embodiment of the projector light source is shown in FIG. 7. Only one channel 610 is shown having parabolic shaped reflective sides 611. Mounting device 402 within the channel mounts alternate red 612, green 613 and blue 614 LEDs. The device of FIG. 8 has a plurality of parallel channels 610 and can produce different coloured light output beams by illuminating different ones of the red, green and blue LEDs as is known in the art.

FIG. 8 is a graph of test data comparing intensity output of a lighting device employing top emitting (TE) and side edge bonded (EBo) LEDs in a reflector. The reflector focal length was 2 mm and the reflector cup total length was 4 mm. The intensity in the normal direction (0 degree) from the reflector with the EBo LED is about twice the intensity obtained with a TE LED. Thus, a lighting device according to the invention projects a more intense beam of light. The inventors also found that the intensity increases with increases in the cup total length from a range of 2 mm to 4 mm.

As is known in the art, current display projectors have a bright white light source with red, green and blue filters that move successively in front of the white light source to produce red, green and blue sub-images of the projector colour output. The two projector lighting devices illustrated in FIGS. 7 and 8 eliminate the need for colour filters as the lighting source can change colour itself between red, green and blue.

In the drawings and above discussions no reference has been made to electronic circuitry and electrical connections for operating the LEDs or light source. LED lighting devices and the like are well known in the art and it is well within the knowledge and capability of the skilled addressee to understand the electrical and electronic requirements of such a device.

What is claimed is:

1. A light source for a lighting device comprising:
a reflector for receiving one or more light emitting diode devices, said reflector having reflective sides and a light exit, and
a side emitting LED device located in the reflector and having its primary light emitting directions towards the reflective sides such that light emitted from the LED device are reflected towards the light exit.

2. The light source of claim 1 wherein the reflector is selected from a group consisting of a cup, dish, cone, or channel.

3. The light source of claim 2 wherein the reflector is a reflective channel for receiving an array of the side emitting LED devices.

4. The light source of claim 3 wherein the array of the side emitting LED devices comprises successive red, green and blue side emitting LED devices.

5. The light source of claim 3 further comprising a plurality of adjacent reflective channels, each channel receiving only a plurality of red or green or blue side emitting LED devices, wherein adjacent reflective channels have successive pluralities of red, green and blue side emitting LED devices.

6. The light source of claim 2 wherein the cup, dish, cone, or channel has a parabolic shaped inner surface having a reflective finish.

7. The light source of claim 1 wherein the reflector has a focal point and the side emitting LED device is mounted on a mounting device such that the light emitting region center is located adjacent the focal point.

8. The light source of claim 1 when used in a device for projecting a bean of light from the device.

9. A lighting device for projecting a bean of light, comprising:
a light reflector having a mounting surface surrounded by parabolic shaped reflective sides and a light exit, and
a light emitting diode devices fabricated for mounting to the mounting surface with a plane occupied by light emitting regions of the devices substantially perpendicular to a plane occupied by the mounting surface such that light emissions of the light emitting regions are projected towards the parabolic sides of the reflector are reflected towards the light exit.

10. The lighting assemble of claim 9 wherein the light reflector has a focal point and the light emitting diode is located adjacent the focal point so that light projected towards the parabolic sides of the reflector is reflected towards the light exit in a highly collimated light beam.

11. A light source for a lighting device, comprising:
a light reflector having a mounting surface surrounded by reflective sides and a light exit, for receiving one or more light emitting diode device, and
light emitting diode devices fabricated for mounting to the mounting surface with the plane occupied by light emitting regions of the devices substantially perpendicular to the plane occupied by the mounting surface such that light emissions of the light emitting regions are projected towards the reflective sides of the reflector are reflected towards the light exit.
